(19) United States
(12) Patent Application Publication
(10) Pub. No.: US 2010/0235731 A1
(43) Pub. Date: Sep. 16, 2010

(54) PORTABLE COMMUNICATION TERMINAL AND COMMUNICATION SERVER

(75) Inventor: Masayoshi Son, Tokyo (JP)

Correspondence Address: MAIER & MAIER, PLLC, 1000 DUKE STREET, ALEXANDRIA, VA, 22314, US

(73) Assignee: SOFTBANK BB CORP., Tokyo (JP)

(21) Appl. No.: 12/301,891

(22) PCT Filed: May 22, 2007
(86) PCT No.: PCT/JP2007/060398

§ 371 Date: Jun. 18, 2009

(30) Foreign Application Priority Data
May 23, 2006 (JP) 2006-142574

(51) Int. Cl. G06F 17/24; G06F 17/30

(52) U.S. Cl. 715/259; 707/802; 707/E17.044

(57) ABSTRACT

A portable communication table comprising a user interface for inputting an operating signal for character input, a dictionary database for storing a conversion dictionary for associating an input character with a converted character, an FED processing section for executing a character conversion program to acquire the operating signal inputted through the interface as an input character, reference the conversion dictionary, and the operation setting data of the character conversion program and controlling the operation of the character conversion program, and a communication interface for transferring the conversion dictionary, the character conversion program and operation setting data to the outside of the communication terminal. The may allow a communication terminal to be replaced with a new model that includes the character input environment of the old model.

### FIELD OF THE INVENTION

The present invention relates to a portable communication terminal which is portable and has character input capability and a communication server.

### BACKGROUND ART

Conventionally, the mobile information terminals such as cellular telephones and PDAs (Personal Digital Assistances) having communication capability have widely been distributed. This type of mobile information terminals is provided with character input capability for writing email, inputting addresses to an address book, and inputting characters to other accessory such as a schedule, together with a menu screen for conducting operations for each functionality in a hierarchical structure in which the operations are grouped in accordance with the functionality. In the case of cellular phones and so forth, while it is often desired to change the used phone model from an old terminal to a new terminal, there are a variety of techniques for system migration (for example, as described in Patent Document 1).

However, in the past, when the used phone model is changed from an old terminal to a new terminal, there has been provided no mechanism for system migration to make it possible to use, with the new terminal, the user interface such as a character input environment, a menu screen and the like which had been available in the old terminal, and thereby there is a problem that the usability for character input is degraded with the new terminal.

### Patent Document 1: Japanese Patent Published Application No. 2001-359160

### DISCLOSURE OF THE INVENTION

Taking into consideration the above circumstances, it is an object of the present invention to provide a portable communication terminal and a communication server so that, when the in-use phone model is changed from an old terminal to a new terminal, it is possible to easily move the character input environment and user interface of the old terminal to the new terminal, and improve the character input environment of the new terminal.

In order to accomplish the object as described above, the present invention provides a portable communication terminal comprising: a user interface configured to receive an operating signal for character input; a dictionary database configured to store and hold a conversion dictionary in which input characters and converted characters are associated with each other; a FEP processing section configured to run a character conversion program which acquires operating signals through the user interface as input characters, convert the acquired input characters into converted characters and output the converted characters; a FEP managing section configured to store and hold the conversion dictionary and the operation setting data of the character conversion program and control the operation of the character conversion program; a transfer interface configured to transfer and output the conversion dictionary, the character conversion program and the operation setting data to the outside of the communication terminal.

The present invention provides a portable communication terminal comprising: a user interface configured to receive an operating signal for character input; a dictionary database configured to store and hold a conversion dictionary in which input characters and converted characters are associated with each other; a FEP processing section configured to run a character conversion program which acquires operating signals through the user interface as input characters, convert the acquired input characters into converted characters and output the converted characters; a FEP managing section configured to store and hold the conversion dictionary and the operation setting data of the character conversion program and control the operation of the character conversion program; an external FEP storing section configured to acquire, store and hold an external conversion dictionary, an external character conversion program and external operation setting data which are input from an external source outside the communication terminal; an external FEP processing section configured to preferentially run the external character conversion program stored and held in the external FEP storing section on the basis of the external conversion dictionary and the external operation setting data stored and held in the external FEP storing section ahead of the character conversion program and the operation setting data.

Preferably, in the invention as described above, the FEP managing section is provided with the functionality of adding environment setting data further to the external operation setting data.

Preferably, in the invention as described above, the FEP managing section is provided with a version database for storing and holding the versions of the character conversion program and conversion dictionary, wherein the transfer interface is used to compare the versions of the character conversion program and conversion dictionary of a destination terminal with the versions stored and held in the version database, and perform the transfer in accordance with the result of comparison.

Preferably, in the invention as described above, the transfer interface is used to transfer only the differences of the conversion dictionary and the character conversion program in accordance with the result of comparison.

Preferably, in the invention as described above, the external FEP processing section runs the user interface with reference to the external configuration data in a virtual environment implemented by an operation program which is acquired from an external source outside the communication terminal.

Another invention provides a communication server which can be connected with the portable communication terminals as recited above, wherein the communication server is provided with the transfer functionality of receiving the conversion dictionary, the character conversion program and the operation setting data from the transfer interface of the old terminal, and transferring the conversion dictionary, the character conversion program and the operation setting data as received to the external FEP storing section of the new terminal.

Preferably, in the invention as described above, there is a transfer determination section configured to compare the conversion dictionary and the character conversion program of the old terminal with those of the new terminal, wherein the transfer functionality is used to transfer all or part of the conversion dictionary, the character conversion program and the operation setting data of the old terminal in accordance with the determination result obtained by the transfer determination section. The transfer functionality is preferably used to replace the conversion dictionary, the character conversion program and the operation setting data by the corresponding data of the latest versions in accordance with the determination result obtained by the transfer determination section, and transfer the conversion dictionary, the character conversion program and the operation setting data after replacement.

Furthermore, another invention provides a portable communication terminal comprising: a user interface configured to display information about user operation and enable a user to input an operating signal in each of a plurality of screens which are provided in a hierarchical structure; a UI configuration database configured to store and hold configuration setting data relating to display information about each screen and the hierarchical structure; a UI processing section configured to construct the hierarchical structure with reference to the configuration setting data; a UI managing section configured to store and hold the configuration setting data and the operation program of the user interface, and control the operation of the user interface; and a communication interface configured to transfer and output the configuration setting data and the operation program to the outside of the communication terminal.

Still further, another invention provides a portable communication terminal comprising: a user interface configured to display information about user operation and enable a user to input an operating signal in each of a plurality of screens which are provided in a hierarchical structure; a UI configuration database configured to store and hold configuration setting data relating to display information about each screen and the hierarchical structure; a UI processing section configured to construct the hierarchical structure as the user interface with reference to the configuration setting data; a UI managing section configured to store and hold the configuration setting data, and control the operation of the user interface in accordance with the configuration setting data; an external UI storing section configured to acquire, store and hold an external configuration setting data which is input from an external source outside the communication terminal; an external UI processing section configured to preferentially use the external configuration setting data stored and held in the external UI storing section ahead of the configuration setting data.

Preferably, in the invention as described above, the UI managing section is provided with the functionality of adding environment setting data to the external configuration setting data.

Preferably, in the invention as described above, the UI managing section is provided with a UI configuration setting database for storing and holding a UI system identifier which identifies the user interface. wherein the transfer interface is used to compare the UI system identifier of a destination terminal with the UI system identifier stored and held in the UI configuration setting database, and perform the transfer in accordance with the result of comparison.

Furthermore, in the invention as described above, the external UI processing section preferably runs the user interface with reference to the external configuration data in a virtual environment implemented by an operation program which is acquired from an external source outside the communication terminal.

A still further invention provides a communication server which can be connected with the above recited portable communication terminal as a first terminal and a second terminal, wherein the communication server is provided with the transfer functionality of receiving the configuration setting data from the transfer interface of the old terminal, and transferring the configuration setting data as received to the external UI storing section of the new terminal.

In the invention as described above, there is a transfer determination section configured to compare the system identifier of the old terminal with that of the new terminal, wherein the transfer functionality is used to transfer the configuration setting data to be transferred together with an operation program for implementing a virtual environment on the external UI processing section of a destination terminal for referring to the configuration setting data.

### BRIEF DESCRIPTION OF THE DRAWINGS

FIG. 1 A block diagram for schematically showing the configuration of the communication system in accordance with a first embodiment.

FIG. 2 A block diagram for showing the operation of a software connection section in accordance with the first embodiment.

FIG. 3 A block diagram for showing the operation of a software connection section in accordance with a modification example of the first embodiment.

FIG. 4 A block diagram for schematically showing the configuration of the communication system in accordance with a second embodiment.

FIG. 5 A explanatory view for showing the menu structure in accordance with the second embodiment.

FIG. 6 A block diagram for showing the operation of a software connection section in accordance with a modification example of the second embodiment.

### BEST MODE FOR CARRYING OUT THE INVENTION

### First Embodiment

### (Configuration of Communication System)

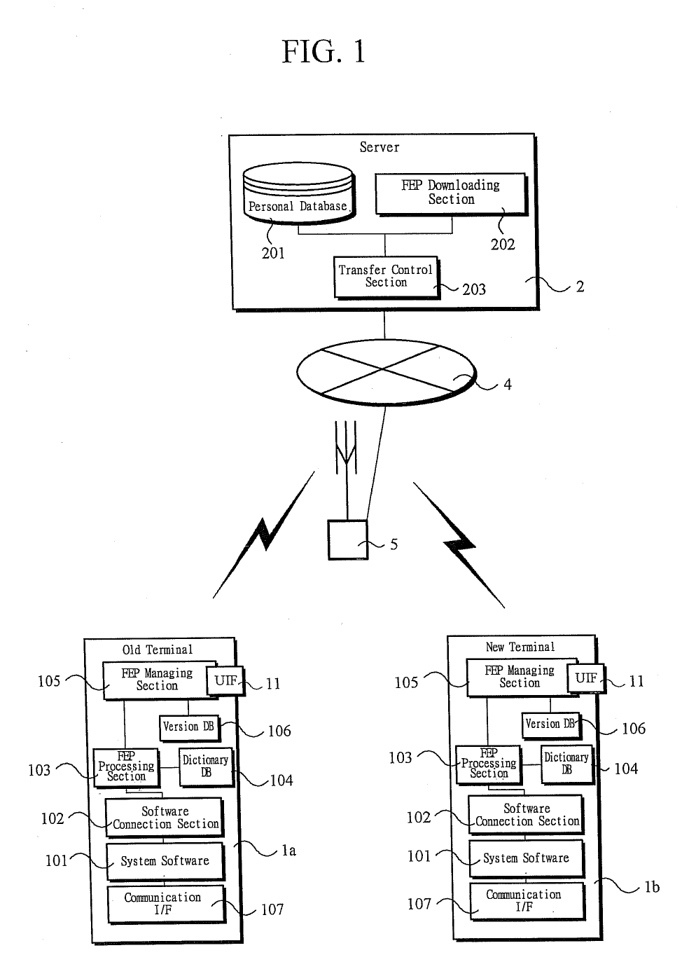

The first embodiment of the present invention will be explained with reference to the drawings. FIG. 1 is a block diagram for schematically showing the configuration of the communication system in accordance with the present embodiment.

The communication terminal 1 (1a or 1b) is a portable telephone equipment capable of receiving communication services such as telephone conversation, data communication and the like through a relay point such as a base station which communicates with cellular phones without wires. The communication methods for this type of cellular phones includes, for example, FDMA, TDMA, CDMA, W-CDMA, PHS (Personal Handyphone System) and so forth. Also, the cellular phone may be provided with functionalities such as digital camera functionality, application software execution functionality, and GPS functionality, and a mobile computer such as a personal digital assistant (PDA) can be used in the same manner as the cellular phone.

Specifically describing, the communication terminal 1 (1a or 1b) is provided with a user interface 11, a dictionary database 104 for storing and holding a conversion dictionary in which input characters and converted characters are associated with each other, a FEP processing section 103 for running a character conversion program (FEP) which acquires operating signals through the user interface 11 as input characters, converts the acquired input characters into converted characters and outputs the converted characters, a FEP managing section 105 for storing and holding the conversion dictionary and the operation setting data of the character conversion program and controlling the operation of the character conversion program, and a communication interface 107 for transferring and outputting the conversion dictionary, the character conversion program and the operation setting data to the outside of the communication terminal 1.

The user interface 11 is a module for displaying the information relating to user operation and enabling the user to input operating signals, and is constructed with a display screen and operation buttons arranged on the front side of the equipment body for inputting operations to perform each functionality and character input.

The FEP managing section 105 serves to acquire, store and hold factory default setting data and external setting data from the outside of the communication terminal 1 (from another communication terminal or the communication server 2), and provided with the functionality of adding, to the setting data, environment setting data acquired by user operation through the user interface 11. Then, the FEP managing section 105 controls the FEP processing section 103 on the basis of the default setting data and the user setting data (external setting data) as selected by user operation through the user interface 11. By this functionality, it is possible to preferentially use the user setting data (external setting data) ahead of the default setting data in accordance with the preference of the user.

Furthermore, the FEP managing section 105 is provided with a version database 106 for storing and holding the versions of the character conversion program and conversion dictionary. The FEP managing section 105 serves to compare the versions of the character conversion program and conversion dictionary of the destination terminal with the versions stored in the version database, and perform transmission through the communication interface 107 in accordance with the result of comparison. Also, at this time, the FEP managing section 105 may transfer only the differences of the conversion dictionary and the character conversion program in accordance with the comparison result of the versions.

The communication interface 107 is provided with the functionality of transferring the conversion dictionary, FEP and setting data to the outside, in addition to the functionality of transferring an external dictionary, external FEP and external setting data, which are input (received) from an external source, to the dictionary database 104, the FEP processing section 103 and the FEP managing section 105 respectively, and storing and holding the data therein. Incidentally, in the case of the present embodiment, when receiving the respective data and programs, these data and programs are stored and held in order to be added to the default data and default programs. However, these received data and programs can be overwritten on the default data and programs. When overwriting, the overwritten data and programs are used as the default data and default programs. Furthermore, of the received data and programs, only portions which correspond to the default data and default programs are overwritten, and the remaining portions are stored and held as additional external data and external programs.

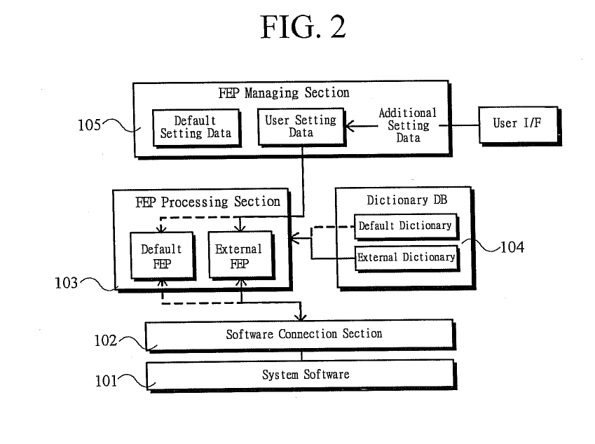

The respective sections cooperate with a system software 101 through a software connection section 102. This software connection section 102 is a module for selectively reading software stored in a memory, and running the software on a CPU to dynamically link an arbitrary application with the system software 101. As illustrated in FIG. 2, with the software connection section 102, it is possible to dynamically select a default FEP or an external FEP under the control of the FEP managing section 105, and run the selected FEP by the FEP processing section 103.

The FEP processing section 103 is a module for running the FEP and providing the functionalities required for running the FEP, and capable of running not only the default FEP, which has been introduced before shipping, but also external FEPs introduced from another communication terminal and the communication server 2 in order to run an arbitrary FEP dynamically selected from among the plurality of FEPs by the software connection section 102. In addition to this, when running the FEP, this FEP processing section 103 reads the setting data provided from the FEP managing section 105, the default setting data and the user setting data (or external setting data acquired from another communication terminal and the communication server 2), reflects the setting data as read in the system, and performs character conversion by the use of the conversion dictionary that is specified by the setting (i.e., the default dictionary or an external dictionary acquired from another communication terminal and the communication server 2).

The conversion dictionary includes a general dictionary and a personal dictionary, which may be transferred together through the communication interface 107. Conversely, it is possible to transfer only part of the dictionaries such as the personal dictionary alone, differential data occurring due to different versions or the like. Incidentally, the FEP to be transferred may be a program which is compatible between the old terminal and the new terminal, a program which provides the functionality equivalent to the old terminal, or a program which add a new function to the program of the old terminal or omit some function from the program of the old terminal.

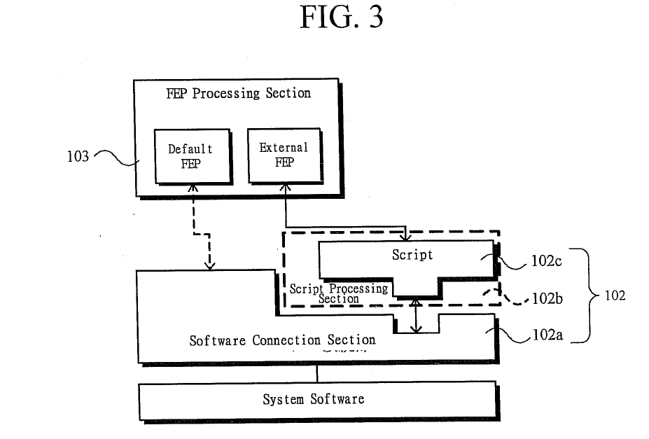

The program (FEP) for adding a new function can be implemented, as illustrated in FIG. 3 for example, by designing the software connection section 102 with a system connection section 102a and a script processing section 102b in order to implement a virtual environment in which a script as acquired from an external source can be run.

The system connection section 102a is a module corresponding to the software connection section 102, but provided also with the functionality of running a script by the script processing section 102b in addition to the functionality of the software connection. The module for implementing the new functionality with the script which is run by the script processing section 102b is linked with the system software 101 through the system connection section 102a.

The script processing section 102b can run the script 102c written in a mark-up language such as Java (registered trademark), XML or HTML and emulate the screen layout which had been displayed by the old terminal on the system software 101.

Then, when running the default FEP, the system connection section 102a directly runs the FEP on the FEP processing section 103, and when running an external FEP, the system connection section 102a runs the script 102c on the script processing section 102b to link the external FEP with the system software through the virtual environment which is emulated. By this configuration, even if the external FEP provides functionality which cannot be directly linked with the system software 101, it is possible to maintain the compatibility with the new terminal.

In accordance with this modification example, the old terminal and the new terminal need not have the same structure for the purpose of running an FEP. But, by installing a script of the external FEP which is compatible with the old terminal, it is possible to run any FEP. The distribution of this script can be performed from the communication server 2 as described above, for example, by registering and managing the models of the old terminal and new terminal of each user when the in-use phone model is changed, and selecting a script supported by the FEP environment on the transfer destination side.

(Communication Server)

In the case of the present embodiment, there is the communication server 2 which can be connected with the old terminal 1a and the new terminal 1b through a radio base station 5 and a communication network 4. This communication server 2 is provided with a personal database 201 for accumulating the information about the FEP used by each user, an FEP downloading section 202 for downloading the latest version of the FEP, and a transfer control section 203 for controlling the transmission of the FEP environment between the new and old terminals.

The transfer control section 203 of the communication server 2 is provided with the functionality of receiving the conversion dictionary, the character conversion program and the operation setting data through the transfer interface of the old terminal 1a, and transferring the conversion dictionary, the character conversion program and the operation setting data, as received, to an external FEP storing section of the new terminal 1b. This transfer process may be automatically performed in response to the access from the old terminal, or performed in response to the user operation.

Also, the transfer control section 203 of the communication server 2 is provided with the functionality of comparing the versions of the character conversion program and conversion dictionary of the old terminal 1a with the corresponding versions of the new terminal 1b, and transferring all or part of the conversion dictionary, the character conversion program and the operation setting data of the old terminal 1a to the new terminal 1b in accordance with the result of comparing the versions. Furthermore, the transfer control section 203 is provided with the functionality of replacing the conversion dictionary, the character conversion program and the operation setting data as received from the old terminal 1a by the corresponding latest versions thereof on the basis of the result of comparing the versions, and transferring the latest versions.

(Action/Effects)

In the case of the present embodiment as described above, after powering up the new terminal 1b for the first time, the FEP managing section 105 interrogates the personal database 201 to retrieve the version information from personal FEP setting data. The retrieved version information is compared with the version information written in the version database 106 before shipping. If the version number of the FEP processing section differs, the FEP and dictionary which are set in the personal database 201 are downloaded through the FEP downloading section 202, and written in the FEP processing to section 103 and the dictionary database 104. On the other hand, if the versions of FEPs match but the versions of dictionaries differ, a general dictionary is downloaded and written in the dictionary database 104. Also, the personal dictionary data is downloaded from the personal database 201 and written in the dictionary database 104.

As has been discussed above, in accordance with the present embodiment, when the in-use phone model is changed from the old terminal 1a to the new terminal 1b, it is possible to easily move the character input environment of the old terminal 1a to the new terminal 1b, and furthermore to improve the character input environment of the new terminal 1b by replacing the respective data by the latest versions from the communication server 2.

### Modification Example

Meanwhile, the present invention is not limited to the above embodiment, but it is possible to add a variety of modification. For example, the transfer may be triggered not only when the new terminal is the powered up, but also automatically when the user invokes the function of moving the setup configuration for system migration. Also, the FEP program and general dictionary may be downloaded directly from the home page of a software development company rather than downloaded from the FEP downloading section 202.

Furthermore, the data stored in the personal database 201 may be uploaded automatically or when the user invokes a data storing process. Still further, when the personal dictionary information is uploaded, only differences from the previous uploaded data may be uploaded.

### Second Embodiment

### (Configuration of Communication System)

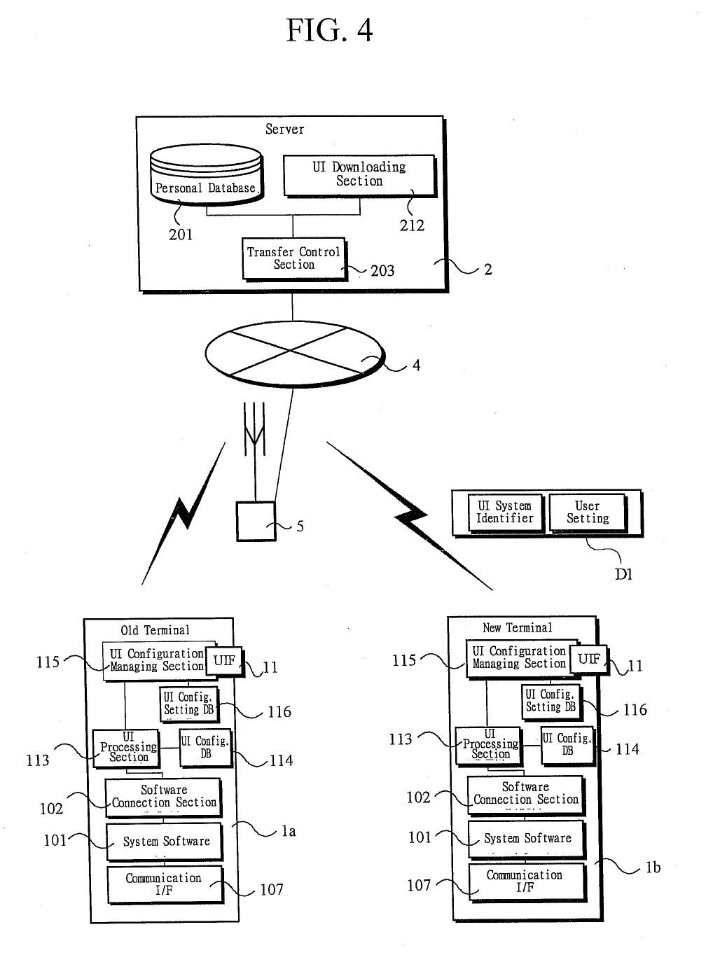

Next, the second embodiment of the present invention will be explained with reference to the drawings. FIG. 4 is a block diagram for schematically showing the configuration of the communication system in accordance with the present embodiment. Meanwhile, in the description of the present embodiment, like reference numbers indicate functionally similar elements as the above first embodiment unless otherwise specified, and therefore no redundant description is repeated.

The communication terminal 1 (1a or 1b) is a portable telephone equipment operable through wireless communication, and provided with a UI configuration setting database 116 for storing and holding configuration setting data with respect to a menu screen, a UI processing section 113 for constructing the menu screen with reference to the configuration setting data, and a UI managing section 115 for controlling the operation of the user interface 11, in addition to the respective modules for character input as described of the first embodiment.

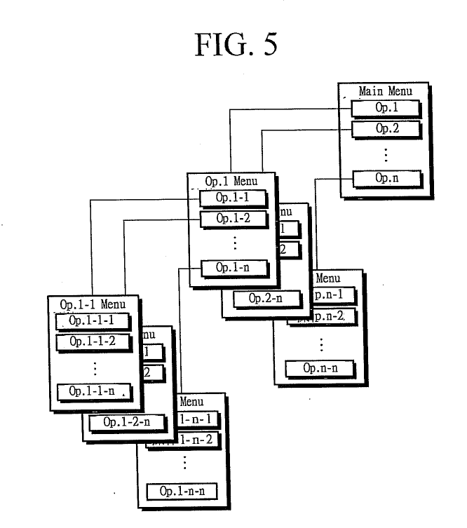

The UI processing section 113 is provided with the functionality of displaying a menu to indicate information about user operation and enable the user to input an operating signal in each of a plurality of menu screens which are provided in a hierarchical structure as illustrated in FIG. 5.

The UI managing section 115 is provided with the UI configuration setting database 116 for storing and holding default configuration setting data introduced before shipping and external configuration setting data acquired from an external source outside of the communication terminal 1 (from another communications terminal and the communications server 2), and the functionality of adding environment setting data in accordance with the user operation through the user interface 11. Then, the UI managing section 115 is provided with the functionality of selecting default setting data and user setting data (external setting) in accordance with the user operation through the user interface 11, and controlling the UI processing section 113 in accordance with this selection. By this functionality, it is possible to preferentially use the user setting data (external setting data) ahead of the default setting data in accordance with the preference of the user.

The UI processing section 113 is provided with a UI configuration database 114 for storing an UI system identifier which is used to identify the type and version of an UI system (a UI program and configuration setting data). The UI managing section 115 compares the UI system identifier of the transfer source terminal with the UI system identifier stored and held in the UI configuration database 114, and performs the transfer through the communication interface 107 in accordance with the result of comparison. In this case, the UI managing section 115 may transfer only either one of the UI program and the UI configuration setting data, or only the differences thereof in accordance with the result of comparing the UI system identifiers.

The communication interface 107 is provided with the functionality of transferring an external UI program and external configuration setting data, which are input (received) from an external source, to the UI configuration setting database 116 and the UI processing section 113 respectively and storing and holding the data therein, in addition to the functionality of transferring the UI program and the configuration setting data to the outside. Incidentally, in the case of the present embodiment, when receiving the respective data and programs, these data and programs are stored and held in order to be added to the default data and default programs. However, these received data and programs can be overwritten on the default data and programs. When overwriting, the overwritten data and programs are used as the default data and default programs. Furthermore, of the received data and programs, only portions which correspond to the default data and default programs are overwritten, and the remaining portions are stored and held as additional external data and external programs.

The respective sections cooperate with a system software 101 through a software connection section 102. This software connection section 102 is a module for selectively reading software stored in a memory, and running the software on a CPU to dynamically link an arbitrary application with the system software 101. With the software connection section 102, it is possible to dynamically select a default UI or an external UI under the control of the UI managing section 115, and run the selected UI system by the UI processing section 113.

The UI processing section 113 is a module for running the UI system and providing the functionalities required for running the UI system, and capable of running not only the default UI system, which has been introduced before shipping, but also external UIs introduced from another communication terminal and the communication server 2 in order to run an arbitrary UI system dynamically selected from among the plurality of UIs by the software connection section 102. In addition to this, when running the UI system, this UI processing section 113 reads the setting data provided from the UI managing section 115, reads the default setting data and the user setting data (or external setting data acquired from another communication terminal and the communication server 2), and reflects the setting data as read in the system.

Incidentally, the UI system to be transferred may be a program which is compatible between the old terminal and the new terminal, a program which provides the functionality equivalent to the old terminal, or a program which add a new function to the program of the old terminal or omit some function from the program of the old terminal.

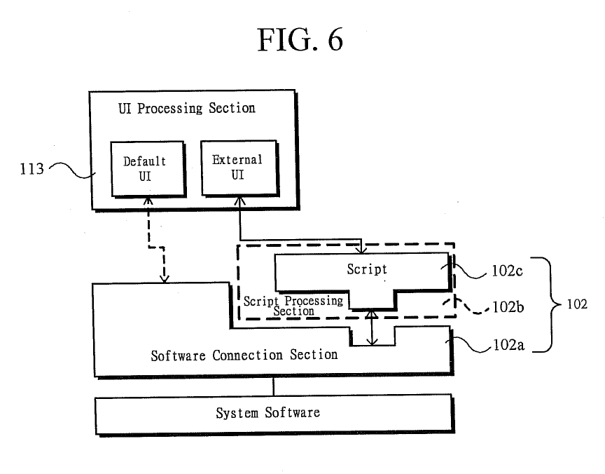

The program (UI) for adding a new function can be implemented, as illustrated in FIG. 6 for example, by designing the software connection section 102 with a system connection section 102a and a script processing section 102b in order to implement a virtual environment in which a script as acquired from an external source can be run to implement the external UI.

The system connection section 102a is a module corresponding to the software connection section 102, but provided also with the functionality of running a script by the script processing section 102b in addition to the functionality of the software connection. The module for implementing the new functionality with the script which is run by the script processing section 102b is linked with the system software 101 through the system connection section 102a.

The script processing section 102b can run the script 102c written in a mark-up language such as Java (registered trademark), XML or HTML and emulate the screen layout which had been displayed in the old terminal on the system software 101. Then, when running the default UI system, the system connection section 102a directly runs the UI system on the UI processing section 113, and when running an external UI system, the system connection section 102a runs the script 102c on the script processing section 102b to link the external UI with the system software through the virtual environment which is emulated. By this configuration, even if the external UI provides functionality which cannot be directly linked with the system software 101, it is possible to maintain the compatibility with the new terminal.

In accordance with this modification example, the old terminal and the new terminal need not have the same structure for the purpose of running an UI system. But, by installing a script of the external UI which is compatible with the old terminal, it is possible to run any UI system. The distribution of this script can be performed from the communication server 2 as described above, for example, by registering and managing the models of the old terminal and new terminal when the in-use phone model is changed, and selecting a script supported by the UI environment on the transfer destination side.

(Communication Server)

Also, in the case of the present embodiment, there is the communication server 2 which can be connected with the old terminal 1a and the new terminal 1b through a radio base station 5 and a communication network 4. The communication server 2 in accordance with the present embodiment is provided with a personal database 201 as discussed above, an UI downloading section 212 for downloading the latest version of the UI, and a transfer control section 203 for controlling the transmission of the UI environment between the new and old terminals.

Also, in the case of the present embodiment, the transfer control section 203 of the communication server 2 is provided with the functionality of comparing the UI system identifiers of the old terminal 1a and the new terminal 1b, and transferring all or part of the user setting and UI program of the old terminal 1a in accordance with the result of comparing the UI system identifiers. Furthermore, the transfer control section 203 is provided with the functionality of replacing the UI program and configuration setting data as received from the old terminal 1a by the corresponding latest versions thereof on the basis of the result of comparing the UI system identifiers, and transferring the UI program and configuration setting data together with a script for emulation as additional data.

(Action/Effects)

In the case of the present embodiment as described above, after powering up the new terminal 1b for the first time, the UI managing section 115 interrogates the personal database 201 to retrieve the version information from personal UI setting data. The retrieved version information is compared with the UI system identifier of the UI configuration database 114. If the version number of the UI processing section differs, the UI system identifier and user setting data which are set in the personal database 201 are downloaded through the UI downloading section 212, and written in the UI processing section 113 and the UI configuration database 114. If the versions of UIs match but the user setting data differs, only the user setting data is downloaded and written in the UI configuration setting database 116.

As has been discussed above, in accordance with the present embodiment, when the in-use phone model is changed from the old terminal 1a to the new terminal 1b, it is possible to easily move the user interface environment such as the menu structure of the old terminal 1a to the new terminal 1b, and furthermore to improve the character input environment of the new terminal 1b by replacing the respective data by the latest versions from the communication server 2.

### Modification Example

Meanwhile, the present invention is not limited to the above embodiment, but it is possible to add a variety of modification. For example, the transfer may be triggered not only when the new terminal is the powered up, but also automatically when the user invokes the function of moving the setup configuration for system migration. Also, the UI program and general dictionary may be downloaded directly from the home page of a software development company rather than downloaded from the UI downloading section 212.

Furthermore, the data stored in the personal database 201 may be uploaded automatically or when the user invokes a data storing process. Still further, when the personal dictionary information is uploaded, only differences from the previous uploaded data may be uploaded.

### INDUSTRIAL APPLICABILITY

As has been discussed above, in accordance with the present embodiment, when the in-use phone model is changed from the old terminal (the first terminal) to the new terminal (the second terminal), it is possible to easily move the user interface environment and the menu structure of the old terminal to the new terminal, and furthermore to improve the character input environment of the new terminal.

What is claimed is:

1. A portable communication terminal comprising:
a user interface configured to receive an operating signal for character input;
a dictionary database configured to store and hold a conversion dictionary in which input characters and converted characters are associated with each other;
a FEP processing section configured to run a character conversion program which acquires operating signals through the user interface as input characters, convert the acquired input characters into converted characters and output the converted characters;
a FEP managing section configured to store and hold the conversion dictionary and the operation setting data of the character conversion program and control the operation of the character conversion program;
a transfer interface configured to transfer and output the conversion dictionary, the character conversion program and the operation setting data to the outside of the communication terminal.

2. A portable communication terminal comprising:
a user interface configured to receive an operating signal for character input;
a dictionary database configured to store and hold a conversion dictionary in which input characters and converted characters are associated with each other;
a FEP processing section configured to run a character conversion program which acquires operating signals through the user interface as input characters, convert the acquired input characters into converted characters and output the converted characters;
a FEP managing section configured to store and hold the conversion dictionary and the operation setting data of the character conversion program and control the operation of the character conversion program;
an external FEP storing section configured to acquire, store and hold an external conversion dictionary, an external character conversion program and external operation setting data which are input from an external source outside the communication terminal;
an external FEP processing section configured to preferentially run the external character conversion program stored and held in the external FEP storing section on the basis of the external conversion dictionary and the external operation setting data stored and held in the external FEP storing section ahead of the character conversion program and the operation setting data.

3. The portable communication terminal as claimed in claim 2,
wherein the FEP managing section is provided with the functionality of adding environment setting data further to the external operation setting data.

4. The portable communication terminal as claimed in claim 1,
wherein the FEP managing section is provided with a version database for storing and holding the versions of the character conversion program and conversion dictionary,
wherein the transfer interface is used to compare the versions of the character conversion program and conversion dictionary of a destination terminal with the versions stored and held in the version database, and perform the transfer in accordance with the result of comparison.

5. The portable communication terminal as claimed in claim 4,
wherein the transfer interface is used to transfer only the differences of the conversion dictionary and the character conversion program in accordance with the result of comparison.

6. The portable communication terminal as claimed in claim 1,
wherein the external FEP processing section runs the character conversion program in a virtual environment implemented by an operation program which is acquired from an external source outside the communication terminal.

7. A portable communication terminal comprising:
a user interface configured to display information about user operation and enable a user to input an operating signal in each of a plurality of screens which are provided in a hierarchical structure;
a UI configuration database configured to store and hold configuration setting data relating to display information about each screen and the hierarchical structure;
a UI processing section configured to construct the hierarchical structure with reference to the configuration setting data;
a UI managing section configured to store and hold the configuration setting data and the operation program of the user interface, and control the operation of the user interface; and
a communication interface configured to transfer and output the configuration setting data and the operation program to the outside of the communication terminal.

8. A program communication terminal comprising:
a user interface configured to display information about user operation and enable a user to input an operating signal in each of a plurality of screens which are provided in a hierarchical structure;
a UI configuration database configured to store and hold configuration setting data relating to display information about each screen and the hierarchical structure;
a UI processing section configured to construct the hierarchical structure with reference to the configuration setting data;
a UI managing section configured to store and hold the configuration setting data, and control the operation of the user interface in accordance with the configuration setting data;
an external UI storing section configured to acquire, store and hold an external configuration setting data which is input from an external source outside the communication terminal;
an external UI processing section configured to preferentially use the external configuration setting data stored and held in the external UI storing section ahead of the configuration setting data.

9. The portable communication terminal as claimed in claim 8,
wherein the UI managing section is provided with the functionality of adding environment setting data to the external configuration setting data.

10. The portable communication terminal as claimed in claim 7,
wherein the UI managing section is provided with a UI configuration setting database for storing and holding a UI system identifier which identifies the user interface,
wherein the transfer interface is used to compare the UI system identifier of a destination terminal with the UI system identifier stored and held in the UI configuration setting database, and perform the transfer in accordance with the result of comparison.

11. The portable communication terminal as claimed in claim 10,
wherein the external UI processing section runs the user interface with reference to the external configuration data in a virtual environment implemented by an operation program which is acquired from an external source outside the communication terminal.

12. A communication server which can be connected with the portable communication terminal as recited in claim 1 (hereinafter referred to as “the old terminal”),
wherein the communication server is provided with the transfer functionality of receiving the conversion dictionary, the character conversion program and the operation setting data from the transfer interface of the old terminal, and transferring the conversion dictionary, the character conversion program and the operation setting data as received to an external FEP storing section a new terminal.

13. The communication server as claimed in claim 1 further comprising a transfer determination section configured to compare the conversion dictionary and the character conversion program of the old terminal with those of the new terminal,
wherein the transfer functionality is used to transfer all or part of the conversion dictionary, the character conversion program and the operation setting data of the old terminal in accordance with the determination result obtained by the transfer determination section.

14. The communication server as claimed in claim 1,
wherein the transfer functionality is used to replace the conversion dictionary, the character conversion program and the operation setting data by the corresponding data of the latest versions in accordance with the determination result obtained by the transfer determination section, and transfer the conversion dictionary, the character conversion program and the operation setting data after replacement.

15. A communication server which can be connected with the portable communication terminal as recited in claim 7 (hereinafter referred to as “the old terminal”),
wherein the communication server is provided with the transfer functionality of receiving the configuration setting data from the transfer interface of the old terminal, and transferring the configuration setting data as received to an external UI storing section of a new terminal.

16. The communication server as claimed in claim 7 further comprising a transfer determination section configured to compare the system identifier of the old terminal with that of the new terminal,
wherein the transfer functionality is used to transfer the configuration setting data to be transferred together with an operation program for implementing a virtual environment on the external UI processing section of a destination terminal for referring to the configuration setting data.

17. A communication server which can be connected with the portable communication terminal as recited in claim 2 (hereinafter referred to as “the new terminal”),
wherein the communication server is provided with the transfer functionality of receiving a conversion dictionary, a character conversion program and a operation setting data from a transfer interface of an old terminal, and transferring the conversion dictionary, the character conversion program and the operation setting data as received to the external FEP storing section of the new terminal.

18. The communication server as claimed in claim 2 further comprising a transfer determination section configured to compare the conversion dictionary and the character conversion program of the old terminal with those of the new terminal,
wherein the transfer functionality is used to transfer all or part of the conversion dictionary, the character conversion program and the operation setting data of the old terminal in accordance with the determination result obtained by the transfer determination section.

19. The communication server as claimed in claim 2,
wherein the transfer functionality is used to replace the conversion dictionary, the character conversion program and the operation setting data by the corresponding data of the latest versions in accordance with the determination result obtained by the transfer determination section, and transfer the conversion dictionary, the character conversion program and the operation setting data after replacement.

20. A communication server which can be connected with the portable communication terminal as recited in claim 8 (hereinafter referred to as “the new terminal”),
wherein the communication server is provided with the transfer functionality of receiving the configuration setting data from a transfer interface of an old terminal, and transferring the configuration setting data as received to the external UI storing section of the new terminal.

21. The communication server as claimed in claim 8 further comprising a transfer determination section configured to compare the system identifier of the old terminal with that of the new terminal,
wherein the transfer functionality is used to transfer the configuration setting data to be transferred together with an operation program for implementing a virtual environment on the external UI processing section of a destination terminal for referring to the configuration setting data.
